(19) United States
(12) Patent Application Publication
(10) Pub. No.: US 2023/0306160 A1
(43) Pub. Date: Sep. 28, 2023

(54) METHOD AND SYSTEM FOR AUTOMATED DESIGN GENERATION FOR ADDITIVE MANUFACTURING UTILIZING MACHINE LEARNING BASED SURROGATE MODEL FOR CRACKING

(71) Applicant: Palo Alto Research Center Incorporated, Palo Alto, CA (US)

(72) Inventors: Amirmassoud Mirzendehdel, Millbrae, CA (US); Morad Behandish, Palo Alto, CA (US); Saigopal Nelaturi, Mountain View, CA (US)

(21) Appl. No.: 17/706,068

(22) Filed: Mar. 28, 2022

(51) Int. Cl. G06F 30/23; G06F 30/17

(52) U.S. Cl. CPC G06F 30/23; G06F 30/17; G06F 2113/10

(57) ABSTRACT

This disclosure teaches techniques, devices, and systems for automatically generating design parameters of a structural model (or any component that is defined by one or more parameters) to be produced by additive manufacturing, using machine-learning models to avoid production failures. In aspects, a topology optimization framework (e.g., with optimization iterations, or loops) is used to efficiently explore the expanded design space of additive manufacturing components is disclosed.

### TECHNICAL FIELD

Implementations of the present disclosure relate to topology optimization.

### BACKGROUND

Additive manufacturing (often known as 3D printing) enables production of structures that optimize strength to weight ratios. For example, hollow structures that are expensive or difficult to achieve in machining processes (i.e., removal of materials by cutting) may be created layer by layer in additive manufacturing. Many forms of additive manufacturing make use of transforming matters from one state to another, such as from liquid to solid, by chemical reactions or by heat (e.g., melting materials at specific locations and solidifying when cooled).

In common examples, plastic or metal particles (e.g., fine powder or liquid) may be flattened on a work area to receive moving laser beams (or an energy source) that locally melt the particles through certain thicknesses to penetrate the current layer of powders and bond to the previous layer. The molten powders then solidify when the laser beams move away. After the laser beams complete a design pattern (e.g., a slice) in one layer, another layer of particles is laid on top. Layer by layer, complicated structures can thus be formed.

When a structure is designed with an optimized strength to weight ratio (e.g., with complicated hollow portions and minimal material used to accomplish designed loads), manufacturing defects can be introduced due to the thermal cycles of melting the particles and allowing them to solidify. Without taking such thermal cycles into consideration, manufacturing of such a structure may fail due to warpage, fracture, cracking, and/or other heat-introduced (the heat may be physical or chemical) deformation or residual stress.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a block diagram of an automatic topology optimization using automatic differentiation on gradients, in accordance with certain aspects of the present disclosure.

FIG. 2 illustrates a block diagram of an automated topology optimization system with experimental validation, in accordance with certain aspects of the present disclosure.

FIG. 3 illustrates an example additive manufacturing system, in accordance with certain aspects of the present disclosure.

FIGS. 4A-4C illustrate a specific example of workflow for optimizing designs of a specific work piece, in accordance with certain aspects of the present disclosure.

FIG. 5 illustrates example training datasets generated for initializing topology optimization for the specific example illustrated in FIGS. 4A-4C, in accordance with certain aspects of the present disclosure.

FIGS. 6A and 6B illustrate computational operations of topology optimization on the specific example illustrated in FIGS. 4A-4C, in accordance with certain aspects of the present disclosure.

FIGS. 7A and 7B illustrate example results of topology optimization on the specific example illustrated in FIGS. 4A-4C, in accordance with certain aspects of the present disclosure.

FIG. 8 illustrates a flow diagram of methods of operations, in accordance with certain aspects of the present disclosure.

FIG. 9 illustrates an example computational device for performing operations of topology optimization, in accordance with certain aspects of the present disclosure.

Like numerals indicate like elements.

### DETAILED DESCRIPTION

The present disclosure provides various techniques for automatically generating designs and/or design parameters (e.g., representation of a design in any format) of a structural model using topology optimization and machine learning to prevent failures related to additive manufacturing.

A component (interchangeable with “structural model” herein) to be designed often faces two requirements. First, the component is required to appear in certain form or shape, in order to fit or be assembled with other components. Second, the component is required to function, such as to withstand certain loads without failure (e.g., deform significantly). For example, a screw may have a form defined by geometric parameters including major diameter, minor diameter, pitch diameter, handedness, angle, lead, pitch, and starts. These form parameters, along with materials properties (and other design parameters), may define a maximum operation load at which the screw may be used (given other considerations, such as safety factors). On the other hand, if the purpose of the screw is known beforehand, such as when the maximum operation load for each screw is known already, optimization of the design parameters may be performed, e.g., to minimize material use, production cost, etc.

Topology optimization may include various computational design techniques for optimizing design parameters, in order to achieve both desired form and function for a given component. For example, topology optimization includes mathematical methods that optimize form parameters within a known design space (e.g., geometry, materials, etc.) for given loading and/or boundary conditions (e.g., confined by neighboring components or parts), in order to maximize certain performance metrics (e.g., maximum allowable elastic deformation, fracture, etc.). Unlike shape optimization, topology optimization may be computed to achieve any shape that is not predefined by known parameter sets. The present disclosure provides topology optimization techniques and methods for automatically generating designs for a structural model based on machine learning, for avoiding production failures during additive manufacturing, in order to achieve optimized forms and functions with high production success rates.

Additive manufacturing presents additional challenges to topology optimization. Selective laser sintering (SLS), selective laser melting (SLM), laser powder bed fusion (LPBF), and other similar additive manufacturing methods rely on locally transforming a printing material from a solid state (e.g., in the form of a powder) to a liquid state (e.g., melted or fused), and from the liquid state to a solid state when cooled. Due to the high temperature and variations in material density in these different states, on each layer the 3D printing materials expands and contracts, experiencing thermal and residual stresses that may cause the structural model to warp or crack. Experimentally prototyping potential designs would be extremely time consuming and cost prohibitive. Therefore, an automated topology optimization method disclosed herein is used to analyze or predict failure and optimize design parameters, to achieve optimized structural designs that avoids production failures in additive manufacturing.

For example, the present disclosure provides an innovative method and system for automatically generating design parameters of a structural model (or any component that is defined by one or more parameters) to be produced by additive manufacturing, using machine-learning models to avoid production failures (herein referred as “producibility”). In aspects, a topology optimization framework (e.g., with optimization iterations, or loops) efficiently explores the expanded design space of additive manufacturing components is disclosed. In an example, the additive manufacturing uses metal powder that experiences drastic temperature changes and thermal stresses and often results in warpage or cracking without proper designs.

The disclosed techniques may ensure producibility or manufacturability (e.g., minimizing risks in cracking, warpage, or fracture due to thermal or residual stresses) at the heat treatment stage (e.g., cooling down or subsequent temperature variations). For example, structural models fabricated by LPBF are often subject to high thermal stresses during the printing process and the residual stresses must be properly addressed. The thermal and/or residual stresses may cause defects such as warpage or cracking in the structural model if the stress values are sufficiently high (e.g., exceeding certain thresholds).

According to aspects of the present disclosure, to ensure that an optimized design remains crack free, an accurate crack-indicating index is defined and evaluated at every topology optimization iteration (also referred to as “loops” as the output of each iteration may be used as input for the next iteration). In other words, in each iteration cycle, two problems are solved. First, a failure analysis with respect to the additive manufacturing processes based on various design parameters is performed. The various design parameters may define: (1) the geometric aspects (e.g., the form, or shape of the structural model), (2) material aspects (physical properties, such as strength, density, thermal properties), and (3) performance aspects (stresses related to expected use) of the structural model.

Second, a topology optimization solution is computed to update one or more of the design parameters toward a design goal, which may be identifying forms for minimizing material use, maximizing performance strength (safety factor), or other definable optimization aspects. The updated design parameters may then be used for the failure analysis in the next iteration cycle. The iterations may continue until certain convergence criteria are reached (i.e., results may not be further improved, thus reaching an optimal state). Because this optimization iteration process is in a loop, the “first” and “second” notations used here are for ease of description purposes only and do not indicate the actual order for the computations or analyses to be performed (e.g., topology optimization may first be performed before the initial failure analyses).

Referring to the failure analyses (involving the additive manufacturing procedures), the present disclosure addresses the simulation of a coupled multi-physics and time-dependent problem. For example, for each layer, the thermal and residual stresses may depend on and be altered by warpage, residual stresses, and thermal states (stresses, temperature, continuing heat dissipation) of the previous layer. As such, the local energy for sintering or melting the powder materials at the current layer may be offset from design slices, further causing residual and thermal stresses to be addressed in the next layers. The “time-dependent” aspect also includes (in addition to heat dissipation) considerations for geometric parameters for the structural model, such as size and complexity for printing completion at each layer. The input power of the energy source (often laser, but may also be extrusion, where appropriate), the material used in printing, and production environment are all included in the simulation, which may use finite element analysis (FEA). The simulation is performed in each topology optimization iteration or cycle. As such, the computation workload is substantial and can be computationally prohibitive.

The present disclosure uses a surrogate model to handle the simulation of the failure analyses. For example, a surrogate model that employs Deep Convolutional Neural Networks (DCNNs) based on the attention-based U-Net architecture to predict the ‘Maximum Shear Strain Index’ (MSSI) values over the volume of the structural model is used in the topology optimization loop.

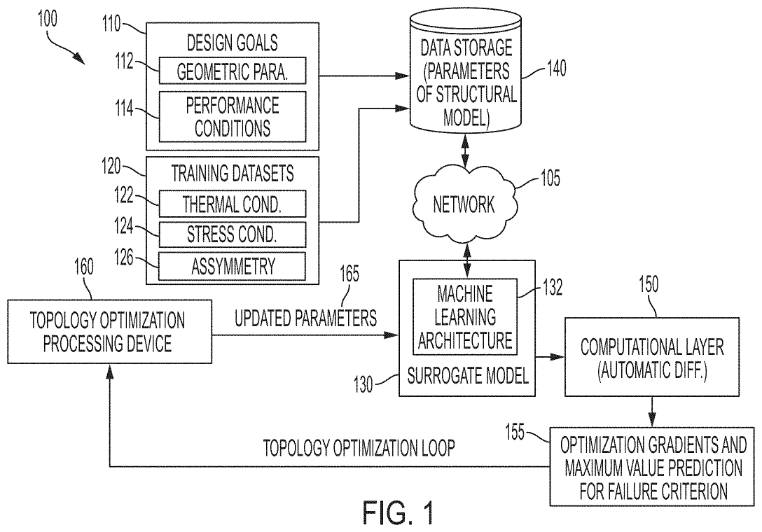

According to aspects of the present disclosure, automatic differentiation is used to directly compute the gradient of maximum MSSI (output of the surrogate model) with respect to the input (design parameters). Then the gradient is augmented with the performance-based sensitivity field (defined in the topology optimization) to optimize the design parameters while considering the trade-off between weight, manufacturability, and performance. A high level summary of the disclosed topology optimization is described in relation to FIG. 1.

FIG. 1 illustrates a block diagram of an automatic topology optimization loop 100 using automatic differentiation on gradients, in accordance with certain aspects of the present disclosure. The topology optimization loop 100 includes the failure analyses with respect to additive manufacturing and expected loading conditions performed by the surrogate model 130, and a topology optimization processing device or apparatus 160 for performing topology optimization (e.g., including an objective function, design space, and constraints).

To define a topology optimization problem, one or more design goals 110 may be stored in the data storage 140. For example, the design goals 110 may include geometric parameters 112 for defining the form or shape of the structural model, and one or more performance conditions 114 for the structural model in operation. To enable machine-learning or artificial intelligence methods at the surrogate model 130, training datasets 120 are also provided to the data storage 140. The training datasets 120 may describe thermal conditions 122, stress conditions 124, and asymmetry behaviors 126 of the thermal conditions 122 and/or the stress conditions 124. The data storage 140 may directly be provided to, or accessible via the network 105 by, the surrogate model 130 (or the machine-learning architecture 132 therein).

At a high level, a surrogate model may include any engineering method used to emulate or approximate (as opposed to accurately computing) an outcome of interest. Design problems are often solved by performing experiments and/or computational simulations for evaluating design objectives and/or constraint functions thereof. Such accurate methods are at the cost of time and workload. Surrogate models alleviate such burden by constructing approximation models that mimic the behavior of the actual simulation models but cost much less, in terms of computation, than the actual simulation models. For example, surrogate models may be constructed using a data-driven or bottom-up approach, as enabled by machine-learning or the like (e.g., behavioral modeling or black-box modeling).

The surrogate model 130 intakes the design parameters of the structural model to be analyzed from the data storage 140, and analyzes residual stresses in additive manufacturing simulations that the surrogate model 130 emulates. The residual stresses may be a stress field and provide metrics (e.g., MSSI) for identifying potential fracture, cracking, or warpage failures. That is, the surrogate model 130 solves the coupled multi-physics and time-dependent problem mentioned above. In some cases, the surrogate model 130 may employ a deep convolutional neural network (DCNN) for estimating a crack index for each design iteration. For example, the machine learning architecture 132 of the surrogate model 130 may be coupled with the DCNN and use the training datasets 120 to sufficiently accurately compute the crack index.

The following description will not reiterate known examples of surrogate models implementing machine-learning for efficiently solving structural and thermal simulations using finite element analyses or the like, such as “Attention-Based 3D Neural Architectures for Predicting Cracks in Designs” by Iyer et al. (https://doi.org/10.1007/978-3-030-86362-3_15, ICANN 2021, LNCS 12891, pp. 179-190, 2021, referred to as “Iyer's surrogate model”), which are fully incorporated by reference herein. The following description focuses on the topology optimization addition and distinguishing aspects from known machine-learning surrogate models for structural and thermal simulations. Importantly, the topology optimization loop using automatic differentiation herein does not require all elements or same/similar configurations of existing machine-learning surrogate model examples. Therefore, Iyer's surrogate model, or other similar machine-learning surrogate model applications, if referenced to, cannot be used to limit the claimed topology optimization loops in any manner contradictory to or inconsistent with the present disclosure.

According to aspects of the present disclosure, a computational layer 150 is added subsequent to the surrogate model 130. The computational layer 150 uses automatic differentiation (or algorithmic differentiation, computational differentiation, auto-differentiation, or autodiff) to handle the output of the surrogate model 130. Automatic differentiation may include various techniques to evaluate the derivative of a function, such as one specified by a computer program that executes a sequence of elementary arithmetic operations (addition, subtraction, multiplication, division, etc.) and elementary functions (exp, log, sin, cos, etc.). Automatic differentiation applies the chain rule repeatedly to these operations to compute the derivatives of any order automatically and accurately.

In some cases, according to the present disclosure, the computational layer 150 uses automatic differentiation to directly compute the optimization gradients and maximum value prediction for failure criterion 155. Based on the computed results, the topology optimization processing device 160 may compute feasible design parameters for the structural model. For example, in each topology optimization loop or iteration, the topology optimization processing device 160 determines updated parameters 165 that updates the design parameters of the structural model in the surrogate model 130, for the next iteration of failure analyses.

In general, topology optimization is a powerful and automated design paradigm. Topology optimization may identify optimized design parameters of a conceptual problem defined in terms of loading and boundary conditions, performance objectives and constraints, and design and manufacturing constraints. Topology optimization enables efficient exploration of large and high-fidelity design spaces. The geometric complexity of structural models generated by topology optimization may not necessarily be feasible in production, even by additive manufacturing. As such, generating ‘producible’ and optimized designs would require explicitly encoding manufacturability within the standard formulation of TO. The present disclosure, as shown in FIG. 1, provides techniques for exploring design manufacturability by additive manufacturing (or any technique that may include complicated heat cycles and thermal or residual stresses). As shown, the topology optimization loop 100 in FIG. 1 couples failure analyses by the surrogate model 130 and the topology optimization processes (e.g., by the computational layer 150 and the topology optimization processing device 160). The optimized design parameters may be determined when certain convergence criterion is met, such as when the changes in the updated parameters 165 fall within a predefined threshold.

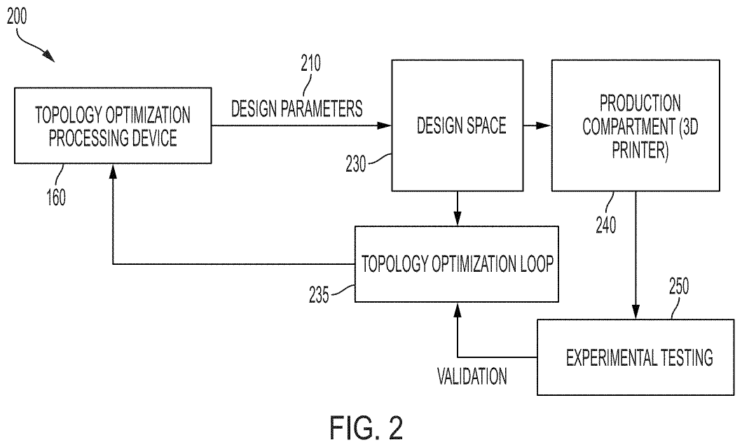

FIG. 2 illustrates a block diagram 200 of an automated topology optimization system with experimental validation, in accordance with certain aspects of the present disclosure. In aspects, the topology optimization loop 235 may be similar to the topology optimization loop 100 (with the topology optimization processing device 160 separately shown for participating in production and experimental validation). As shown in FIG. 2 and in relation to FIG. 1, the design space 230 may receive one or more updated design parameters 210 from the topology optimization processing device 160. The design parameters 210 may correspond to part or all of the updated parameters 165, the geometric parameters 112, and other parameters of the structural model available in the data storage 140 of FIG. 1.

Upon identifying a set of satisfactory design parameters 210 (e.g., when convergence conditions are met), the design space 230 (e.g., a computational device storing and/or modifying the design parameters 210) may forward the design parameters 210, in the original or a different format, to the production compartment 240, which may include an additive manufacturing system, such as a 3D printer utilizing LPBF, SLS, SLM, or similar technologies. The production compartment 240 produces a physical model of the structural model represented by the design parameters 210. The physical model may then be sent to the experimental testing station 250, which records the states and conditions of the physical model.

For example, the experimental testing station 250 may measure, such as by scanning, the geometric properties of the physical model to identity deformations introduced during production. The deformations reflect the residual stresses in the physical model. The experimental testing station 250 may also measure deformations of the physical model under intended loading conditions, to identify whether the physical model has intended strength, elasticity, and other properties. These measurements are then provided to the topology optimization loop 235 to validate one or more models therein (including the surrogate model, material properties, and other assumptions or conditions).

When the measurements correspond to the simulations by the one or more models, the accuracy or validity of the topology optimization is confirmed. When the measurements deviate from the simulated results, the topology optimization processing device 160 may update the related assumptions or conditions (e.g., in one or more parameters of the design parameters 210) accordingly to continue performing topology optimization in the future cycles.

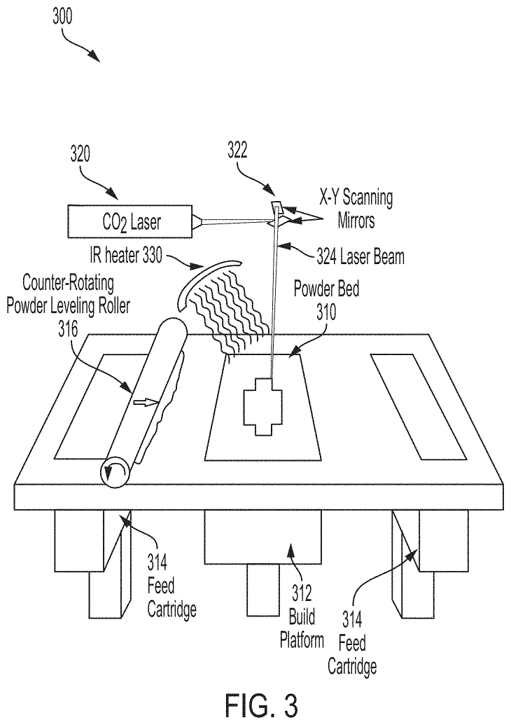

FIG. 3 illustrates an example additive manufacturing system 300, in accordance with certain aspects of the present disclosure. The additive manufacturing system 300 may be used in the place of the production compartment 240 of FIG. 2. FIG. 3 illustrates a general concept of LPBF, SLS, or SLM type of additive manufacturing process. The present disclosure may be applicable to other types of heat related (physical or chemical) additive manufacturing processes.

As shown in FIG. 3, the additive manufacturing system 300 includes a powder bed 310 on a build platform 312 for providing each layer to be formed according to designs. Feed cartridges 314 and the powder leveling roller 316 provide fresh powder for the next layer once the current layer formation has been completed. A laser 320 directed by scanning mirrors 322 uses laser beams 324 to locally turn the powders into a continuous piece of solid. A radiator 330 provides heat to control the rate of cooling and heat treatment to the fused solid layer. According to the present disclosure, the optimized parameters of the structural model may relate to various aspects of the production process and prevent warpage and cracking due to thermal and residual stresses. That is, the structural model optimized for performance would also be producible by the additive manufacturing system 300 or the like.

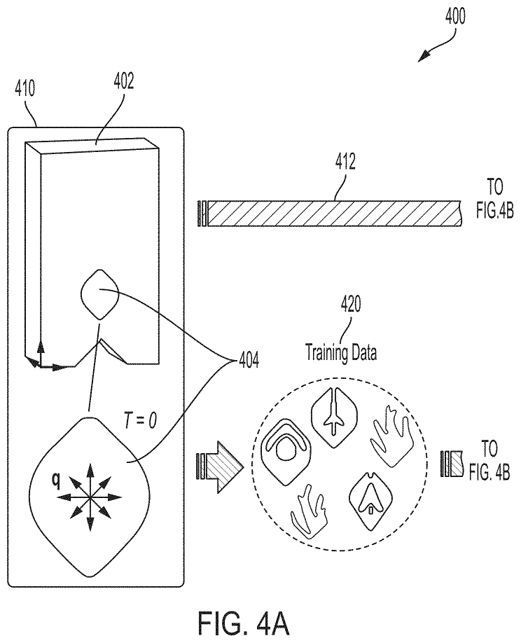

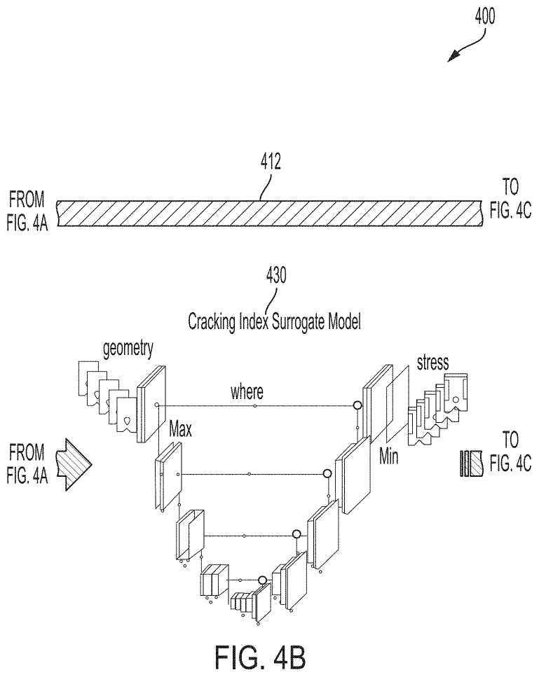

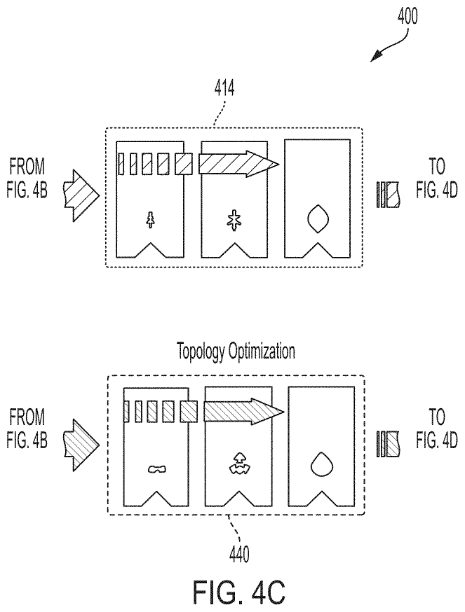

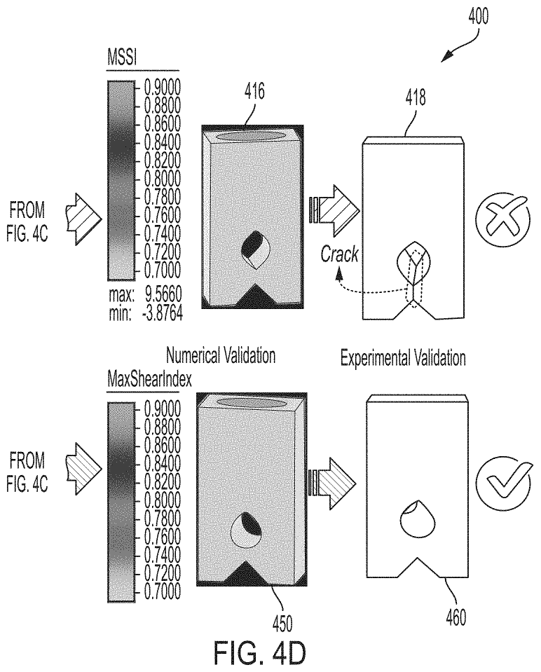

FIGS. 4A-4C illustrate a specific example of workflow 400 for optimizing designs of a specific work piece 402, in accordance with certain aspects of the present disclosure. The workflow 400 corresponds to the block diagram 200 of FIG. 2. As an example, the work piece 402 includes a hole or cavity 404. The hole 404 is to be optimized, such as for cooling purposes or for weight reduction purposes. The design space 410 includes various design parameters that define the optimization problem, including defining the geometric properties of the coupon shape of the work piece 402, the symmetry of the hole 404, one or more production limitations (e.g., related to support during additive manufacturing), material properties (e.g., strength and/or heat conduction), loading conditions, boundary conditions, and the like.

Upon settling on the design space 410, two design methods are used for comparison. The upper path shown in FIGS. 4A-4C uses conventional topology optimization 412 without considering additive manufacturing producibility. By comparison, the lower path shown in FIGS. 4A-4C performs topology optimization considering such producibility by applying the topology optimization loops shown in FIGS. 1 and 2 discussed above.

For example, conventional topology optimization 412 may be performed to identify improved design parameters 414, which are then analyzed with numeral validation 416 and produced as a first physical model 418. Because the topology optimization 412 does not consider defects that may be introduced during manufacturing, the experimental validation 418 shows that a crack developed. The present disclosure uses a set of training data 420 that teach a surrogate model 430 in simulating different physical aspects of additive manufacturing, and iterations of topology optimizations 440 are performed for identifying optimal designs of the hole 404. This results in both the numerical validation 450 and experimental validation of a second physical model 460 showing successful production and performance free from the fracture or cracking shown in the numerical model 416 and the first physical model 418.

According to aspects of the present disclosure, the topology optimization processing device 160 may be used to compute a set of design parameters that define a structural model, such as the work piece 402 and the hole 404 therein. The topology optimization processing device 160 may include a memory and a processing device unit coupled to the memory. The processing device unit and the memory may provide a set of initial parameters to a surrogate model (e.g., the surrogate model 130 of FIG. 1) emulating a failure simulation of the structural model based on one or more training datasets (e.g., the training data 420).

The processing device unit may further apply a computational layer, such as the computational layer 150, to process the output of the surrogate model. For example, the computational layer may obtain one or more gradients by automatic differentiation and a predicted value of a failure criterion. In some cases, the failure criterion relates to thermal induced failure, such as warpage, fracture, or cracking of the work piece 402. In some cases, the memory and the processing device unit may be separately coupled to the topology optimization processing device 160. That is, the processing device unit may be a separate, detached, or remote computational entity with respect to the topology optimization processing device 160, which may be dedicated to perform topology optimization operations. For example, the processing device unit may be on a system level and on a control level that provides user input interface, couples with other computational modules in the topology optimization loop, and output signals for monitoring purposes.

The topology optimization processing device 160 may also compute, using the one or more gradients and the predicted value, an updated set of parameters representing an updated version of the structural model (e.g., the work piece 402). The predicted value may include one or more of: a predicted peak value, a predicted average value, an integral value, 2-norm (or generally p-norm), among other values indicative of a failure criterion. The updated sets of parameters may then be used for a next computational cycle. In some cases, the topology optimization processing device 160 computes the set of initial parameters in a previous computation cycle. The updated set of parameters may be provided to the surrogate model in a next computation cycle.

The topology optimization processing device 160 may identify the set of design parameters based on one or more cycles of computation upon satisfying a convergence condition. For example, the convergence condition may be met when the updated set of parameters are within certain thresholds of changes of the parameters of the previous cycle. In view of both FIGS. 2 and 4, in some cases, the additive production compartment 240 may produce a physical copy of the structural model using the set of design parameters identified by the topology optimization processing device 160.

For example, the failure criterion may include a maximum shear stress index (MSSI) exceeding a threshold value for indicating cracking of the structural model during manufacturing. In some cases, the MSSI may be a function of thermal related variables.

According to aspects of the present disclosure, computing, using the one or more gradients and the predicted value (e.g., peak value) by the topology optimization processing device 160 may include solving an example optimization problem defined below.

In the example of the specific work piece 402 of FIGS. 4A-4C, the design objective may include minimizing, for a design variable ρ, (1−ω)φ(u)+ωζ(ρ), such that:
a state equation K(ρ) u(ρ)=f is solved using finite element analysis,
   a volume constraint

$$\frac{V ( ρ )}{{V}_{t a r g e t}} - 1 \leq 0$$

is satisfied,

0≤ρ≤1, and

0≤ω≤1

wherein:
φ is a performance function of the structural model under design load;
ζ is a cracking index of the structural model considering thermal and residual stress during manufacturing;
ω is a weighting factor,
ρ is a pseudo-density design variable,
u is a state variable that satisfies the state equation,
K is a stiffness matrix of the structural model,
f is a load vector representing external loading conditions, and
V_{target} is a target volume fraction.

In some cases, the failure simulation of the structural model simulates an additive manufacturing process in the additive production compartment. The additive production compartment may form the structural model layer by layer; for a position in each layer, heat a material from a first solid state to a fluid state; and allow the material in the fluid state to dissipate heat and return to a second solid state; wherein the updated version of the structural model is prevented from cracking due to thermal conditions related to phase changes, such as transitions from the first solid state to the fluid state and from the fluid state to the second solid state.

According to aspects of the present disclosure, the set of initial parameters may include attributes defining geometric and material properties of the structural model; and definitions for at least one of a boundary condition, a loading condition, or a thermal condition of the structural model. The one or more training datasets (e.g., the training data 420) may correspond to manufacturing conditions of at least one of: thermal conditions, stress conditions, or asymmetric behaviors thereof.

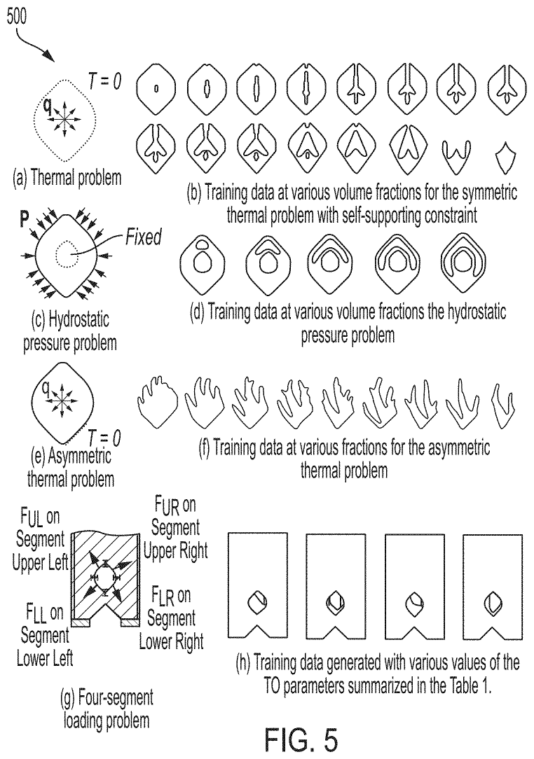

As shown in FIGS. 4A-4C, the producibility-aware topology optimization framework enables the topology optimization loop (e.g., 100 of FIG. 1) to incorporate producibility of additively manufactured parts directly into the design process. As shown, the example surrogate model 430 may use a deep neural network predictor to analyze for failures caused by thermal or residual stresses. The training data 420 provide a diverse set of optimized designs in different thermal and structural performance conditions to augment the sensitivity field with a producibility sensitivity field (e.g., MSSI here) obtained through automatic differentiation (e.g., performed by the computational layer 150 of FIG. 1) to generate feasible designs that will remain crack-free after post-processing, which may include heat treatment. Examples of the training data 420 are shown in FIG. 5.

FIG. 5 illustrates example training datasets 500 generated for initializing topology optimization for the specific example illustrated in FIGS. 4A-4C, in accordance with certain aspects of the present disclosure. In order to accurately perform failure analyses or prediction, sufficient training data under different physics and boundary conditions need be provided to the topology optimization loop. The training datasets 500 also consider relevant design and manufacturing constraints.

As shown in FIG. 5, part (a) and (b) illustrate the thermal conduction problem and a small sample of symmetric self-supporting designs of the channel to maximize thermal conductivity at different volume fractions. Part (c) shows the hydrostatic pressure problem, where the initial design domain is slightly modified to include a self-supporting through-cut channel. The optimized designs for the hydrostatic pressure problem are shown in part (d), where the structural compliance is minimized. Parts (e) and (f) illustrate an asymmetrical thermal problem and the corresponding optimized designs at different volume fractions, respectively.

In addition to the constant thermal and pressure loading, a set of 3D topology optimization problems has been considered featuring varying distribution of surface loading on the surface of the channels. To be specific, the channel surface of a baseline/initial design is divided into four segments (see part (g), in the upper left, upper right, lower left, and lower right segments). The objective of solving the topology optimization problems is structural compliance minimization. In order to introduce sufficient diversities into the training data set, the surface loading applied on each of these segments can vary independently. In addition, two levels of volume fraction constraints are considered to further diversify the generated geometries.

An additive manufacturability filter may be applied to ensure the generated geometries are free from self-support issues in additive fabrication. This maintains the relevancy of the training data for the surrogate model. In the examples shown, a total of 540 geometries has been generated through this approach. A small set of the generated samples are shown in part (h) of FIG. 5.

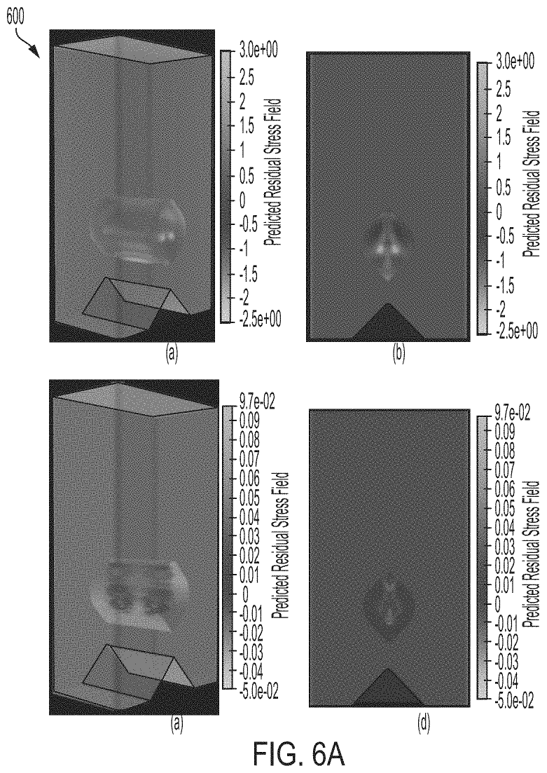

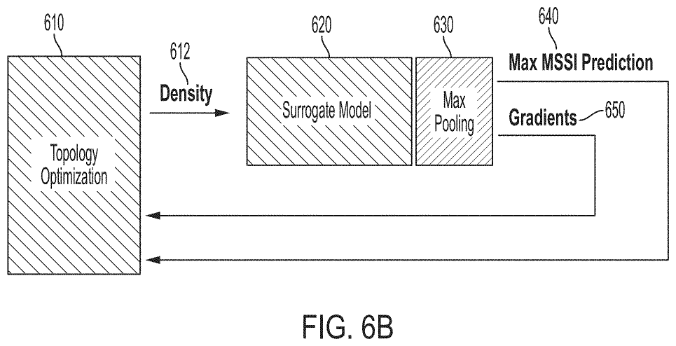

FIGS. 6A and 6B illustrate computational operations and example results 600 of topology optimization on the specific example illustrated in FIGS. 4A-4C, in accordance with certain aspects of the present disclosure. As shown, FIG. 6A describes the maximum shear strain index (MSSI) field inside the hole 404 in parts (a) and (b) and the corresponding gradient field of maximum values in parts (c) and (d). In some cases, the surrogate model 130 or 430 may output the computation results as shown in FIG. 6A.

As shown in FIG. 6B, the MSSI computational results, such as the MSSI sensitivity field prediction 640 and gradients 650, may then be computed using automatic differentiation. For example, according to aspects of the present disclosure, the topology optimization loop 610 may compute the maximum MSSI sensitivity field 640 using a max pooling layer 630 (e.g., the computational layer 150 of FIG. 1) with a pool size as large as the domain size. With the processing performed by the max pooling layer 630, the surrogate model 620 may predict the peak MSSI value rather than the full MSSI field. Subsequently, automatic differentiation is used to compute the change of the output (e.g., in the next iteration) of the neural network (e.g., maximum MSSI) in the surrogate model 620. The change may include one or more hypothetical changes in the input design parameters (e.g., pseudo-density 612). The topology optimization loop 610 may continue with numbers of iterations until certain convergence conditions are met, such as the density 612 change has become within a threshold value.

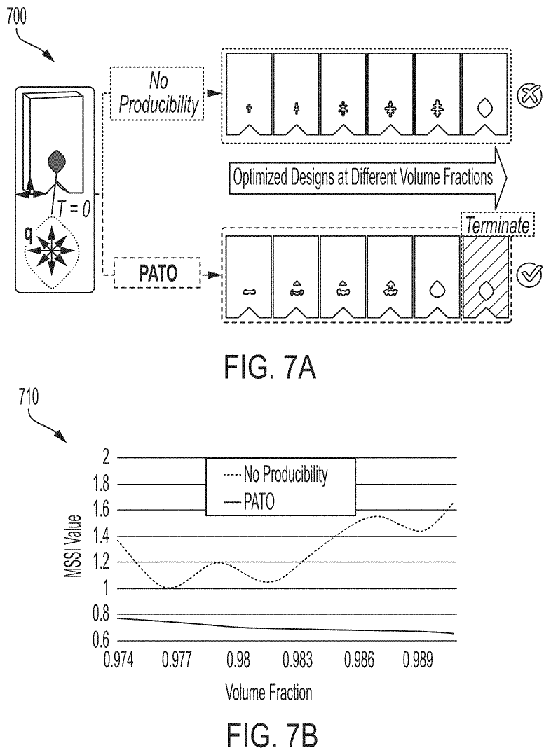

FIGS. 7A and 7B illustrate example results 700 and 710 of topology optimization on the specific example illustrated in FIGS. 4 and 6, in accordance with certain aspects of the present disclosure. As shown on the top portion of FIG. 7A, the optimized designs at different volume fractions for topology optimization without considering producibility (e.g., w=0.0 of the topology optimization problem). In the lower portion of FIG. 7A (e.g., w=0.95), according to aspects of the present disclosure, different designs are iterated for minimizing thermal compliance and under the loading condition of FIG. 7a. As shown, the producibility-aware topology optimization (PATO) designs are qualitatively different from the designs generated by the topology optimization without considering failure situations of additive manufacturing. For example, in the PATO results, the material is removed farther from the notch to reduce the maximum MSSI value. Similarly, FIG. 7B shows the maximum MSSI values at different volume fractions. As expected, the PATO designs have lower maximum MSSI values consistently.

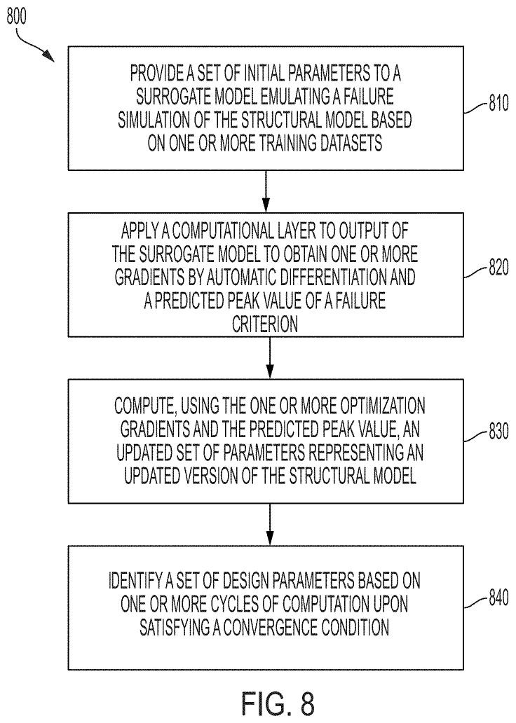

FIG. 8 illustrates a flow diagram of methods of operations 800, in accordance with certain aspects of the present disclosure. For example, the processes described with reference to FIG. 8 may be performed by the topology optimization processing device 160 as described with reference to FIGS. 1 and 2.

The operations 800 begins at 810, by providing a set of initial parameters to a surrogate model that emulates a failure simulation of the structural model based on one or more training datasets.

At 820, a computational layer is applied to the output of the surrogate model for obtaining one or more gradients by automatic differentiation and/or a predicted value of a failure criterion.

At 830, by using the one or more optimization gradients and/or the predicted value, an updated set of parameters may be computed to represent an updated version of the structural model.

At 840, a set of design parameters, such as an optimized set of design parameters, is identified based on one or more cycles of computation upon satisfying a convergence condition.

Various operations are described as multiple discrete operations, in turn, in a manner that is most helpful in understanding the present disclosure, however, the order of description may not be construed to imply that these operations are necessarily order dependent. In particular, these operations need not be performed in the order of presentation.

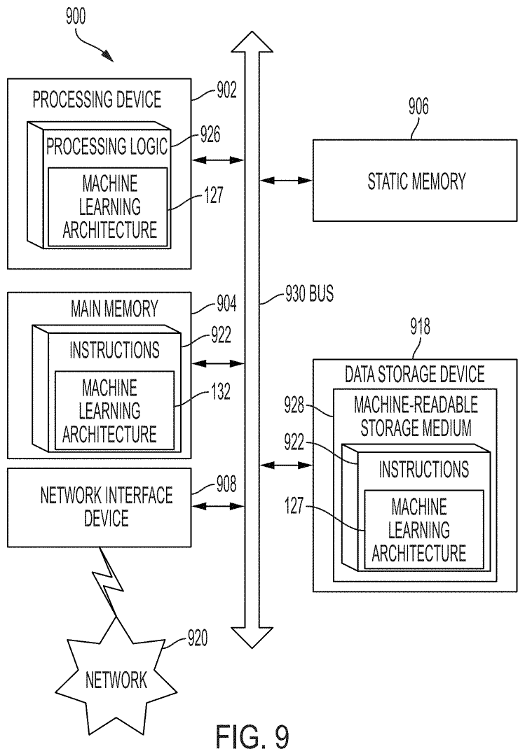

FIG. 9 illustrates a diagrammatic representation of a machine in the example form of a computer system 900 within which a set of instructions 922, for causing the machine to perform any one or more of the methodologies discussed herein (such as the operations 800), may be executed. In various embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 900 may be representative of a server computer system, such as system 100.

The exemplary computer system 900 includes a processing device 902, a main memory 904 (e.g., read-only memory (ROM), flash memory, dynamic random access memory (DRAM), a static memory 906 (e.g., flash memory, static random access memory (SRAM), etc.), and a data storage device 918, which communicate with each other via a bus 930. The processing device 902 may be implemented as the topology optimization processing device 160 or a related processing device unit, a system processing device (e.g., including the computational layer 150), or both. In some cases, the processing device 902 may be used to perform tasks associated with the surrogate model 130. Any of the signals provided over various buses described herein may be time multiplexed with other signals and provided over one or more common buses. Additionally, the inter929 connection between circuit components or blocks may be shown as buses or as single signal lines. Each of the buses may alternatively be one or more single signal lines and each of the single signal lines may alternatively be buses.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 may execute processing logic 926, which may be one example of system 100 shown in FIG. 1, for performing the operations and steps discussed herein.

The data storage device 918 may include a machine-readable storage medium 928, on which is stored one or more set of instructions 922 (e.g., software) embodying any one or more of the methodologies of functions described herein, including instructions to cause the processing device 902 to execute system 100. The instructions 922 may also reside, completely or at least partially, within the main memory 904 or within the processing device 902 during execution thereof by the computer system 900; the main memory 904 and the processing device 902 also constituting machine-readable storage media. The instructions 922 may further be transmitted or received over a network 920 via the network interface device 908.

The non-transitory machine-readable storage medium 928 may also be used to store instructions to perform the methods and operations described herein. While the machine-readable storage medium 928 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof

What is claimed is:

1. An apparatus for computing a set of design parameters defining a structural model to be manufactured, the apparatus comprising:
a memory;
a processing device unit operatively coupled to the memory, the processing device unit to:
provide a set of initial parameters to a surrogate model emulating a failure simulation of the structural model based on one or more training datasets;
apply a computational layer to output of the surrogate model to obtain one or more gradients by automatic differentiation and a predicted value of a failure criterion; and
a topology optimization processing device to compute, using the one or more gradients and the predicted value, an updated set of parameters representing an updated version of the structural model.

2. The apparatus of claim 1, wherein the topology optimization processing device computes the set of initial parameters in a previous computation cycle, and wherein the processing device unit further to:
provide the updated set of parameters to the surrogate model in a next computation cycle; and
identify the set of design parameters based on one or more cycles of computation upon satisfying a convergence condition.

3. The apparatus of claim 2, further comprising:
an additive production compartment to produce the structural model using the set of design parameters.

4. The apparatus of claim 3, wherein the failure criterion comprises a maximum shear stress index (MSSI) exceeding a threshold value for indicating cracking of the structural model during manufacturing, and wherein the MSSI is a function of thermal related variables.

5. The apparatus of claim 4, wherein computing, using the one or more gradients and the predicted value by the topology optimization processing device, the updated set of parameters comprising:
minimizing, for a design variable such that a state equation is solved using finite element analysis when a volume constraint is satisfied; the state equation is based on at least: a performance function of the structural model under design load; a cracking index of the structural model considering thermal and residual stress during manufacturing; a weighting factor, and a target volume fraction.

6. The apparatus of claim 5, wherein the failure simulation of the structural model simulates an additive manufacturing process in the additive production compartment to:
form the structural model layer by layer;
for a position in each layer, heat a material from a first solid state to a fluid state; and
allow the material in the fluid state to dissipate heat and return to a second solid state; wherein the updated version of the structural model is prevented from cracking due to thermal conditions related to phase changes.

7. The apparatus of claim 1, wherein the set of initial parameters comprises:
attributes defining geometric and material properties of the structural model; and
definitions for at least one of a boundary condition, a loading condition, or a thermal condition of the structural model.

8. The apparatus of claim 1, wherein the one or more training datasets correspond to manufacturing conditions of at least one of: thermal conditions, stress conditions, or asymmetric behaviors thereof.

9. A method of computing a set of design parameters defining a structural model to be manufactured using a surrogate model emulating a failure simulation of the structural model based on a set of initial parameters and one or more training datasets, the method comprising:
applying a computational layer to output of the surrogate model to obtain one or more gradients by automatic differentiation and a predicted value of a failure criterion; and
computing, using the one or more gradients and the predicted value by a topology optimization processing device, an updated set of parameters representing an updated version of the structural model.

10. The method of claim 9, wherein the set of initial parameters are computed by the topology optimization processing device in a previous computation cycle, and wherein the updated set of parameters are provided to the surrogate model in a next computation cycle; and the method further comprising:
identifying the set of design parameters based on one or more cycles of computation upon satisfying a convergence condition.

11. The method of claim 9, wherein the set of initial parameters comprises:
attributes defining geometric and material properties of the structural model; and
definitions for at least one of a boundary condition, a loading condition, or a thermal condition of the structural model.

12. The method of claim 9, wherein the one or more training datasets correspond to manufacturing conditions of at least one of: thermal conditions, stress conditions, or asymmetric behaviors thereof.

13. The method of claim 9, wherein the failure criterion comprises a maximum shear stress index (MSSI) exceeding a threshold value for indicating cracking of the structural model during manufacturing, and wherein the MS SI is a function of thermal related variables.

14. The method of claim 13, wherein computing, using the one or more gradients and the predicted value by the topology optimization processing device, the updated set of parameters comprising:
minimizing, for a design variable such that a state equation is solved using finite element analysis when a volume constraint is satisfied; the state equation is based on at least: a performance function of the structural model under design load; a cracking index of the structural model considering thermal and residual stress during manufacturing; a weighting factor, and a target volume fraction.

15. The method of claim 14, wherein the failure simulation of the structural model comprises simulating an additive manufacturing process comprising:
forming the structural model layer by layer; and
for a position in each layer, heating a material from a first solid state to a fluid state and allowing the material in the fluid state to dissipate heat and return to a second solid state; and
wherein the updated version of the structural model is prevented from cracking due to thermal conditions related to phase changes.

16. A non-transitory computer-readable storage medium having instructions stored thereon that, when executed by a processing device for computing a set of design parameters defining a structural model to be manufactured, cause the processing device to:
provide a set of initial parameters to a surrogate model emulating a failure simulation of the structural model based on one or more machine-learning training datasets;
apply a computational layer to output of the surrogate model to obtain one or more gradients by automatic differentiation and a predicted value of a failure criterion; and
compute, using the one or more gradients and the predicted value, an updated set of parameters representing an updated version of the structural model.

17. The non-transitory computer-readable storage medium of claim 16, wherein the set of initial parameters are computed by the topology optimization processing device in a previous computation cycle, and wherein the updated set of parameters are provided to the surrogate model in a next computation cycle.

18. The non-transitory computer-readable storage medium of claim 17, further comprises instructions stored thereon to cause the processing device to identify the set of design parameters based on one or more cycles of computation upon satisfying a convergence condition.

19. The non-transitory computer-readable storage medium of claim 16, wherein the set of initial parameters comprises:
attributes defining geometric and material properties of the structural model; and
definitions for at least one of a boundary condition, a loading condition, or a thermal condition of the structural model.

20. The non-transitory computer-readable storage medium of claim 16, wherein the one or more training datasets correspond to manufacturing conditions of at least one of: thermal conditions, stress conditions, or asymmetric behaviors thereof.
